(19) United States
(12) Patent Application Publication
(10) Pub. No.: US 2026/0046024 A1
(43) Pub. Date: Feb. 12, 2026

(54) SYSTEM AND METHOD FOR GAUSSIAN BOSON SAMPLING

(71) Applicant: Danmarks Tekniske Universitet, Kongens Lyngby (DK)

(72) Inventors: Jonas Schou Neergaard-Nielsen, Kongens Lyngby (DK); Jacob Hastrup, Kongens Lyngby (DK); Ulrik Lund Andersen, Kongens Lyngby (DK); Abhinav Verma, Kongens Lyngby (DK)

(73) Assignee: Danmarks Tekniske Universitet, Kongens Lyngby (DK)

(21) Appl. No.: 19/101,409

(22) PCT Filed: Aug. 21, 2023
(86) PCT No.: PCT/EP2023/072929

§ 371 Date: Feb. 5, 2025

(30) Foreign Application Priority Data
Aug. 19, 2022 (EP) 22191299.1

(51) Int. Cl. H04B 10/073; G06N 10/60; H04B 10/63

(52) U.S. Cl. CPC H04B 10/073; G06N 10/60; H04B 10/63

(57) ABSTRACT

The present disclosure relates to a system and a method of performing Gaussian boson sampling via time multiplexing correlation of squeezed vacuum states for quantum information experiments. One embodiment relates to a method for performing Gaussian boson sampling comprising the steps of—generating a set of pulsed pairs of squeezed vacuum states,—performing time 2024/038212 multiplexed correlation of multiple of such pairs of squeezed vacuum states,—measuring, via a homodyne detection, a state from the pairs of generated squeezed vacuum states,—feed-forwarding the homodyne result of the measured states to a displacement unit,—performing displacement operations on the remaining state from the pairs of generated squeezed vacuum states, and—counting the states output from the displacement unit.

### CROSS-REFERENCE TO RELATED APPLICATIONS

The present application is the National Phase entry of International Patent Application No. PCT/EP2023/072929, filed Aug. 21, 2023, which claims priority to European Patent Application No. 22191299.1, filed Aug. 19, 2022, the entire contents of both are hereby incorporated by reference into this application.

### TECHNICAL FIELD

The present disclosure relates to a system and a method of performing Gaussian boson sampling via time multiplexing correlation of squeezed vacuum states for quantum information experiments.

### BACKGROUND

Boson sampling is a method in the field of photonics used to demonstrate quantum supremacy, among other applications. It consists of N single photons injected into an M-mode interferometer, consisting of beam splitters, phase shifters and photon detectors measuring the outputs. Calculating the probability of detecting photons on each photon detector is a classically intractable problem, with a computational complexity exponentially increasing in the number of detected photons. For a large enough number of photons a classical computer cannot predict the outcomes of the boson sampling experiment.

However, due to imperfections such as loss, distinguishability of the photons, dark counts, phase fluctuations, etc. performing a boson sampling experiment can only approach to a certain degree the theoretical model defining the experiment. Since this sampling approximation is also a classically hard problem, the boson sampling experiment can still outperform the classical computer simulation in the presence of realistic experimental noise sources. In other words, the task of the boson sampling experiment is to produce a sample distribution as similar as possible to the theoretical interferometer defined by N and M. Photon losses and experimental errors increase with the size of the boson sampling interferometer, until a point where the problem can be simulated classically. Thus, the limiting factor of a boson sampling experiment is typically the finite efficiency of single photon sources and the requirement of synchronizing single-photon sources. Hence, it is needed to design an experimental setup complex enough to achieve quantum supremacy while being small enough to avoid undesired noise generation and photon losses.

Gaussian boson sampling is an implementation of boson sampling that is recently gaining interest in the photonics field, particularly in the demonstration of quantum supremacy experiments. Whereas boson sampling experiments require the use of single photons, Gaussian boson sampling uses squeezed vacuum as input states. This implies that the distribution function of the states follows Gaussian statistics due to the Gaussian nature of the input states.

For these reasons, improvements and simplifications on the experimental set up of Gaussian boson sampling experiments will benefit the quality of the generated output and help to demonstrate the concept of quantum supremacy using this platform.

### SUMMARY

Considering the prior art described above, it is a purpose of the present invention to demonstrate a novel approach of performing boson sampling to obtain quantum supremacy using an optical platform. A non-classical source of light, such as two mode squeezed states, is proposed for use in homodyne detection time multiplexing boson sampling due to the ability of being generated on demand instead of single photon states.

The present disclosure therefore relates to a system for performing Gaussian Boson Sampling, comprising an optical input generator configured for generating squeezed vacuum states. The system preferably comprises a time multiplexing unit configured for receiving from the optical input generator and transmitting at least a first part of the generated squeezed vacuum states through a first optical line, receiving from the optical input generator and transmitting at least a second part of the generated squeezed vacuum states through a second optical line, correlating the first part of the squeezed vacuum states from the first optical line and the second part of the squeezed vacuum states from the second optical line using a plurality of beam splitters, delaying the states in the second optical line using a number of delay lines located between the plurality of beam splitters. Hence, the first optical line, the second optical line, the plurality of beam splitter, and/or the number of delay lines are typically part of the time multiplexing unit.

The system may also comprise a measuring unit employing a combination of homodyne detection, displacement operation and photon counting. In one embodiment the measuring unit is configured for measuring a property of the optical inputs at the end of one of the first or the second optical line, preferably by means a homodyne detector. In the other of the first or the second optical line, the optical input can be delayed, such that an output signal, based on the measured property, can be feed-forwarded and provided to an optical displacement operator unit along with the delayed optical input. The optical input can be delayed by means of a delay line, in particular a “long” delay line that is long enough (in distance and/or in time) to “wait” for the measured property. In here the delay line(s) in the measuring unit is termed “final delay line”. Hence, the optical displacement operator unit is preferably located after the final (long) delay line. Displacement operations can then be provided by means of the optical displacement operator, and the optical inputs can be counted after the optical displacement operator, preferably by means of a photon counter.

In one embodiment the measuring unit is arranged such that the homodyne detection is provided in only one of the first optical line or the second optical line, whereas photon counting is provided in only the other of the first or the second optical line. I.e. the measuring unit is configured for delaying the states in the second optical line with a final (long) delay line located after the last beam splitter (of the time multiplexing unit), measuring a property of the states using a homodyne detector at the end of the first optical line, feed-forwarding an output signal, based on the measured property, to an optical displacement operator unit located after the final delay line in the second optical line, applying displacement operations to the states in the second optical line, and counting the photons at the end of the second optical line. An example of this setup is illustrated in FIG. 1A.

However, more flexibility is provided if the choice of which squeezed states are measured by homodyne detection and which by photon counting is not determined by the optical line. This can be provided if for example the measuring unit is configured for switching between homodyne detection and photon counting for each optical input on both the first and the second optical line. E.g. the measuring unit may comprises a switch on each optical line, preferably a highspeed switch, for switching between homodyne detection and photon counting on each optical line. In this more flexible approach each of the photon counters may be preceded by a final delay line and an optical displacement operator unit, and where both the homodyne detector output signals can be feed-forwarded to the corresponding displacement operator unit. An example of this more flexible setup is illustrated in FIG. 1B.

In the presently disclosed approach it is possible to reduce the number of optical components in order to achieve quantum supremacy by means of time multiplexing Gaussian boson sampling experiments. The reduction of components reduces the loss of states, the computational requirements for manipulating with high speed enough for the optical devices and the undesired noise generation in the optical systems, which are typically the limiting factors when testing for quantum supremacy by means of photonic platforms.

Note that the final delay line(s), the homodyne detector(s), the optical displacement operator(s), and/or the photon counter(s) are typically part of the measuring unit.

The present disclosure further relates to a method for performing Gaussian boson sampling, the method comprising the steps of
a) generating a set of pulsed pairs of squeezed vacuum states,
b) performing time multiplexed correlation of multiple of such pairs of squeezed vacuum states,
c) measuring, via a homodyne detection, a state from the pairs of generated squeezed vacuum states,
d) feed-forwarding the homodyne result of the measured states to a displacement unit,
e) performing displacement operations on the remaining state from the pairs of generated squeezed vacuum states, and
f) counting the states output from the displacement unit.

This can for example be executed using the system disclosed herein.

The present disclosure further relates to a measuring unit for receiving squeezed vacuum states, as disclosed herein.

### BRIEF DESCRIPTION OF THE DRAWINGS

The invention will in the following be described in greater detail with reference to the accompanying drawings:

FIGS. 1A-B show schematic views of homodyne assisted time multiplexing Gaussian boson sampling optical setups;

FIG. 2 shows a schematic view of the induced couplings on the squeezed vacuum states on the proposed optical setup;

FIGS. 3A-B illustrate the detection principles of FIGS. 1A-B;

FIG. 4A shows a simulation of the Kolmogorov-Smirnov statistic for a setup comprising two delay lines of a length L₁=1 and L₂=8;

FIG. 4B shows a simulation of the Kolmogorov-Smirnov statistic for a setup comprising three delay lines of a length L₁=1, L₂=2 and L₃=4;

FIG. 5 shows a histogram distribution of elements from a simulation of the unitary matrix obtained with respect to the amplitude;

FIG. 6 shows a histogram distribution of elements from a simulation of the unitary matrix obtained with respect to the phase;

FIG. 7 shows the distribution of the amplitude elements of the induced interferometers compared with an ideal interferometer picked from the Haar measure. The results show an average of seven experiments;

FIG. 8 shows the distribution of the phase elements of the induced interferometers compared with an ideal interferometer picked from the Haar measure. The results show an average of seven experiments;

FIG. 9 shows the distances of the ensemble of states created by linear measurements (FIG. 1A) and the flexible approach (FIG. 1B) from a reference ensemble of states;

FIG. 10A shows the schemes of “linear measurements” from FIG. 1A and the flexible approach from FIG. 1B;

FIG. 10B shows the experimental results in form of unitary matrices that result in the induced states; and

FIGS. 11A-D show a six mode graph state generated by the linear measurement scheme along with the interferometer that induces it and the amplitude and phase elements of the unitary matrix.

### DETAILED DESCRIPTION

Boson sampling was originally proposed as an experimentally simple approach to demonstrate quantum supremacy, although constructing a sufficiently large interferometer with many non-classical optical input sources and detectors is relatively challenging. For this reason, it is of interest to develop any experimental improvement that reduces the physical resources involved in such a setup, relaxing the tight demands required to achieve quantum supremacy via boson sampling. Such a setup can be implemented by Gaussian cluster state generation, in which a number of entangled Gaussian states are generated using a fixed amount of beam splitters and optical input generators, by utilizing the concept of time multiplexing correlation. In principle, it is possible to implement arbitrary Gaussian operations using a two dimensional Gaussian cluster state comprising optical squeezed modes and thus any linear optical network can be simulated with a Gaussian cluster state.

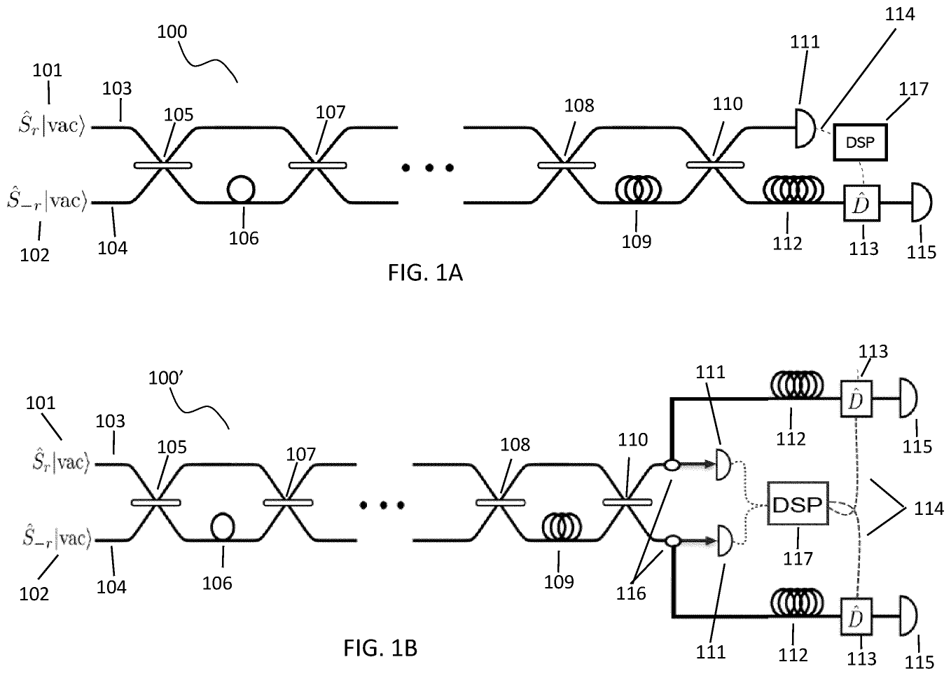

FIGS. 1A and 1B show examples of setups 100, 100′for homodyne-assisted boson sampling. Pairs of single squeezed states 101 and 102 are created by one or more optical input generators. Said pairs are separated by a period of time from the next generated pair. Typically, the shorter the period, the higher the computational power of the presented optical setup. A duration limit of the generation time period may be the computational processing speed limit of the generated data. One of the squeezed Substitute Specification-Clean states comprising the pair of generated squeezed states is injected in a first optical line 103 and the second squeezed state is injected in a second optical line 104. Preferably, the optical lines carrying squeezed states are typically comprised by optical fiber, e.g. a standard single mode optical fiber (SSMF), although they can also be comprised by free air or photonic waveguides.

A first 50:50 beam splitter device 105 is located between the first and second optical lines, correlating the squeezed states arriving at the same time from the optical input generators. The first optical line after the beam splitter carries the correlated squeezed state emerging from one part of the beam splitter, whereas the second optical line comprise a delay line 106. Said delay line is designed such as the length induces a time delay L to the correlated squeezed state emerging from the other part of the beam splitter that is equal to the time generation period of the pairs of squeezed modes. Thereafter, a second 50:50 beam splitter 107 is placed between the first and second optical lines, correlating the squeezed states arriving from the first beam splitter 105 and the delay line 106 located in the second optical line at the same time.

The structure comprised by a beam splitter 108, the first optical line 103, the second optical line 104, and the delay line 109 on the second optical line 104 is defined as a structure unit and can be repeated in series. Each addition of a structure unit includes a longer delay line than its previous one, such that the squeezed states in the second optical line 104 are delayed a higher number of time period units L in every unit structure, compared to the squeezed states generated at the same time travelling through the first optical line 103. Such a strategy to correlate and mix squeezed states based on delay lines and 50:50 beam splitters is defined as time-multiplexing. This operation generates a highly correlated multi-mode Gaussian state which enables to simulate universal Gaussian networks. In general, time multiplexing requires fewer optical components to correlate photons than the widely used spatial-multiplexing.

In a preferred embodiment, a homodyne-assisted boson sampling measuring unit is located after the series of structure units of 50:50 beam splitters and delay lines responsible for performing the time-multiplexing of the squeezed modes. FIGS. 1A and 1B shows two different examples of homodyne-assisted boson sampling measuring units. In the setup 100 in FIG. FIG. 1A, a final beam splitter 110 sends squeezed states to the first optical line 103, wherein a homodyne detector 111 measures them using a variable quadrature basis for each squeezed mode. These quadrature bases can be chosen randomly for demonstration of quantum supremacy. Alternatively, they can be programmed to be in a fixed pattern that allows to implement a desired linear optical network. The final beam splitter 110 sends squeezed states to the second optical line 104 wherein they are delayed, i.e. temporally stored, in a final (long) delay line 112. The homodyne measurement of the squeezed states of the first optical line 103 transforms the correlations of the squeezed states of the second optical line 104 in a way determined by the correlations induced by the optical input state generators 101-102 and the series of structure units 105-110, as well as by the quadrature basis settings of the homodyne detector 111. Due to the non-zero mean vector arising from the homodyne measurements of the squeezed modes, a displacement operation must be performed to the squeezed states in the second optical line 104. Hence, the final delay line 112 storing/delaying the squeezed states must be long enough to allow the homodyne detector to transmit its measurements (via optical line 114 and digital signal processor (DSP) 117) to the displacement unit 113 located in the second optical line 104. A final photon counter 115 is located at the end of the second optical line 104, i.e. after the displacement unit 113. The DSP is preferably configured to process the homodyne measurement outcomes and calculate the necessary displacements to be fed-forward before the photon counter.

Increased flexibility can be provided by the setup 100′in FIG. 1B. In FIG. 1B the homodyne-assisted measuring unit from FIG. 1A has been duplicated such the measuring unit from FIG. 1A is available to both the first optical line 103 and the second optical line 104. By having a 1×2 switch 116 on each output of the last beam splitter 110, it is possible to choose which of the first optical line 103 and the second optical line 104 are measured by homodyne detection and which by photon counting. Hence, at each of the two outputs from the last beam splitter 110, a measuring unit is provided, each measuring unit comprising a homodyne detector 111 and a delay 112+displacement 113+photon counter unit 115−and this can be selected correspondingly by two 1×2 switches 116. The measured output from the homodyne detectors 111 in FIG. 1B can be feed-forwarded 114 to the corresponding displacement units 113 via a digital signal processor (DSP) 117.

The delay line(s) in the measuring unit, termed the “final” delay line in here, is typically used to “park” the light in one of the optical lines while the other line is being measured. I.e. the light is temporarily stored while the other line is being measured, but in practice the light is just delayed in the final delay line. In that regard the final delay line(s) in the measuring unit is preferably at least longer than the longest of the delay lines in the interferometer, i.e. the structure units. Not necessarily much longer, but in practice it would be preferred to make the final delay line a few times (for example 1, 2, 3 or 4 times) longer than the longest delay line in the structure units, i.e. the interferometer, but that is not a requirement. Hence, once the length of the first delay line 106 in the first structure unit has been selected, the remaining delay lines, for example the last delay line 109 and the final delay line 112 in the measuring unit, can be selected from there.

Please note that that when using the term “length” about a delay line can refer both to the physical length and to the length in time. For example if using an optical fiber as delay line; the length of the optical fiber scales with the duration of the delay, i.e. the length of such an optical fiber based delay line can be physical length and/or duration of delay.

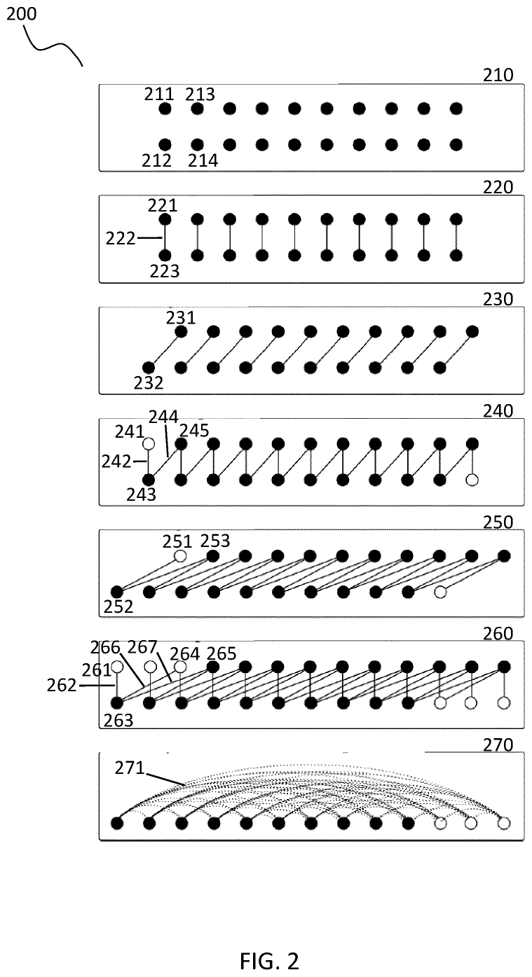

In an alternative embodiment, the beam splitters may be set in an arbitrary configuration different from the balanced 50:50. This configuration may allow to obtain a bigger parameter space on the obtained results FIG. 2 shows a schematic description of the couplings generated on the squeezed states 200 on the homodyne-assisted boson sampling setup described above. Black circles, such as 211, denote squeezed states and open circles such as 241 denote vacuum states. In 210, the squeezed states 211, 213 and the rest of the black circles from the top row are being carried through a first optical line. Squeezed states 212, 214 and the rest of the black circles from the bottom row are being carried through the second optical line. In 220, the squeezed states are sent through the first beam splitter. This generates a coupling between the squeezed states entering the beam splitter at the same time, defined as the solid black line 222 between the squeezed states 221 and 223.

After the first beam splitter, in 230 a first delay line of length L₁=1 is introduced in the second optical line, causing a time delay on these states 232 of 1 period of time compared to the correlated squeezed states from the first optical line 231. The squeezed states enter a second beam splitter in 240 and they become coupled to the states entering the beam splitter at the same time. The squeezed state 243, which had previously been coupled to the squeezed state 245 through the coupling 222/244 would now be coupled to the vacuum state 241 through the coupling 242. In 250 a second delay line with a defined length of L₂=2 further delays the squeezed states in the second optical line. Such a delay line of length L₂=2 is used as an example of a Gaussian boson sampling experimental setup and might have a different length in different setup arrangements. Entering a last beam splitter in 260, the squeezed state 263, which had previously been coupled to the squeezed state 265 through the coupling 222/244/267 and to the vacuum state 264 through the coupling 242/266, would now be coupled to the vacuum state 261 through the coupling 262. The optical setup shown in FIG. 2 and comprising two delay lines is an example of the herein disclosed time multiplexing Gaussian boson sampling. Similar setups with small modifications may be generated with a different number of components.

Homodyne detection is performed in 270 on the squeezed states from one of the first or second optical line. Then, the measurement is feedforwarded to a displacement unit which performs displacement operations on the squeezed states from the other of the first or second delay line, wherein each of the dotted lines illustrate the resulting correlations between squeezed states in the other of the first or the second optical line.

In the approach presented in FIGS. 1 and 2, fewer homodyne measurements are performed than what is required to simulate universal Gaussian networks. This aids to keep the required squeezing level reasonable and to make the experimental realization practical, although time multiplexing Gaussian boson sampling is not restricted exclusively to the combination disclosed herein as it allows more complex implementations. The setups illustrated in FIGS. 1A and 1B are very experimentally friendly. In principle, the number of optical lines is not restricted to two and the number of setup units comprising delay lines and beam splitters is not limited to two. However, comparable to other optical setups, the ultimate limit on the scalability of the presently disclosed system is determined by photon losses along the optical lines, errors on the homodyne measurement, errors on the displacement operations and errors on the photon counting.

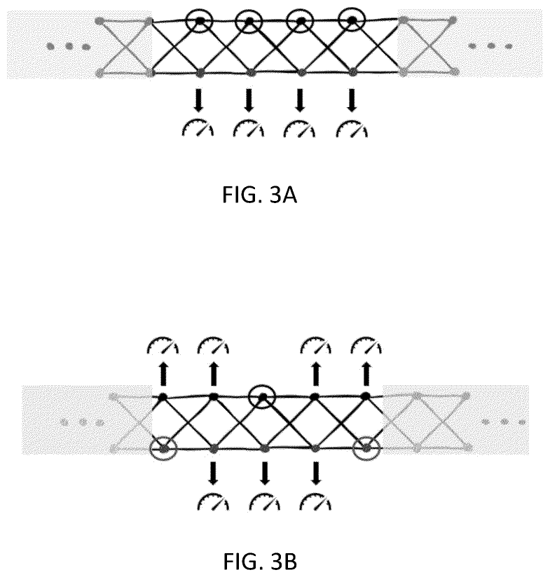

One possible alternative embodiment that allows for a wider range of implemented Gaussian networks is illustrated in FIG. 3B, which can be implemented using the setup in FIG. 1B. Whereas FIG. 3A illustrates the approach with homodyne detection fix to one optical line and photon counting to another optical line, i.e. a sort of “linear measurement”. The graph in FIG. 3A illustrates the correlations obtained with a single structure unit, corresponding to the state obtained after 240 in FIG. 2, but it can be generalised to an arbitrary number of structure units. The dots with arrows and meters in FIG. 2 indicate the squeezed states on the first optical line measured by homodyne detection, while the circled dots indicate the squeezed states on the second optical line measured by photon counters.

FIG. 3B illustrates a measurement strategy exemplified in FIG. 1B where the choice of which squeezed states are measured by homodyne detection and which by photon counting is not determined by the optical line. In this particular example in FIG. 3B, five squeezed states are measured by homodyne detection and three squeezed states are measured by photon counting. To implement such a variable choice of measurement, both optical lines can for example be equipped with an optical 1-to-2 switch at the location after beam-splitter 110, as illustrated in FIG. 1B. As seen in FIGS. 1B and 3B the result is that consecutive output modes can alternate between the two spatial modes and be separated by two temporal modes. Hence, more than half of the modes can be measured by homodyning, and the output modes, which are photon counted, and are circled in the FIG. 2, are separated by a “jump”.

Gaussian boson sampling has been demonstrated to be useful on experiments with applications in fields such as graph-theory and in simulating molecular vibronic spectra. Alternative setups to perform homodyne detection time multiplexing Gaussian boson sampling might be possible and may introduce simplifications to the setup.

### EXAMPLES

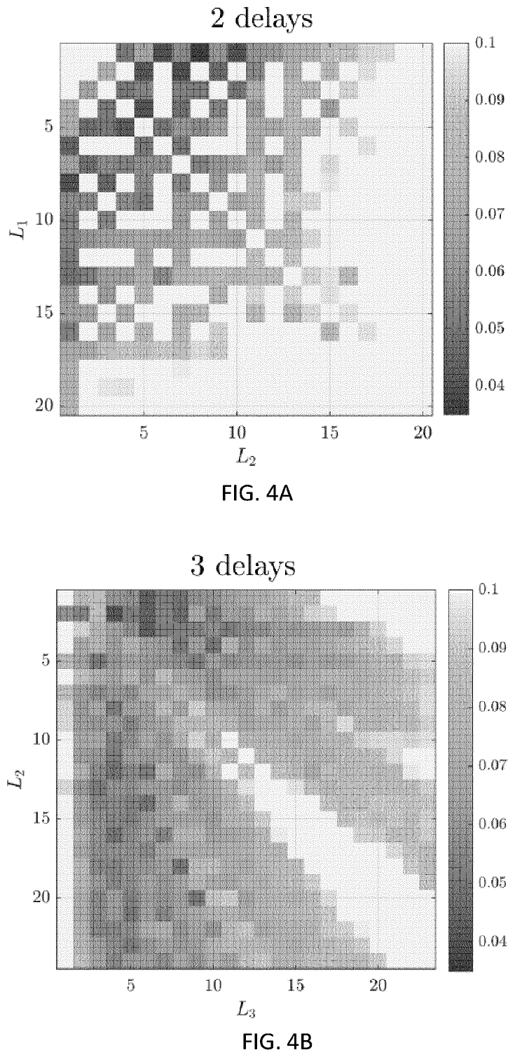

FIG. 4A shows a Kolmogorov-Smirnov statistical test simulation showing the distance of the implemented Gaussian unitaries from a Haar random matrix for the herein disclosed homodyne assisted Gaussian boson sampler. In the simulation, the optical setup comprise two setup units (as described in FIG. 2) varying from L=[1, 20], both in units of the squeezed state generation period of time. The x-axis corresponds to the delay length of the delay line L₂ and the y-axis corresponds to the delay line L₁. Based on the presented simulation, optimal values for L₁ and L₂ are [L₁, L₂]=[1, 8], which correspond to the smallest value in the Kolmogorov-Smirnov statistical test.

FIG. 4B shows a Kolmogorov-Smirnov statistical test simulation showing a further plot of the distance of the implemented Gaussian unitaries from a Haar random matrix for the herein disclosed homodyne assisted Gaussian boson sampler. In the simulation, the optical setup comprise three structure units (as described in FIG. 2), with a fixed first delay line at a length of L₁=1 and L₂ and L₃ varying from L=[1, 20], all in units of the squeezed state generation period of time. The x-axis corresponds to the delay length of the delay line L₃and the y-axis corresponds to the delay line L₂. Based on the presented simulation, optimal values for L₂ and L₃ are [L₂, L₃]=[2, 4], which correspond to the smallest value in the Kolmogorov-Smirnov statistical test. This distance is slightly smaller than for the simulation from FIG. 4A with two delay lines. Hence, based on the simulations presented in FIGS. 4A and 4B, the addition of a third setup unit and delay line improves the results obtained by the Gaussian boson sampler herein disclosed, compared to the example comprising two setup units and two delay lines.

The simulations shown in FIGS. 4A and 4B comprised a setup that generated 100 input modes and 5 dB squeezing of the states. In each simulation, the basis of the homodyne measurement is randomly chosen. Simulations were repeated 100 times, and FIGS. 4A-B show the smallest achieved KS statistic for each setting of the delay paths.

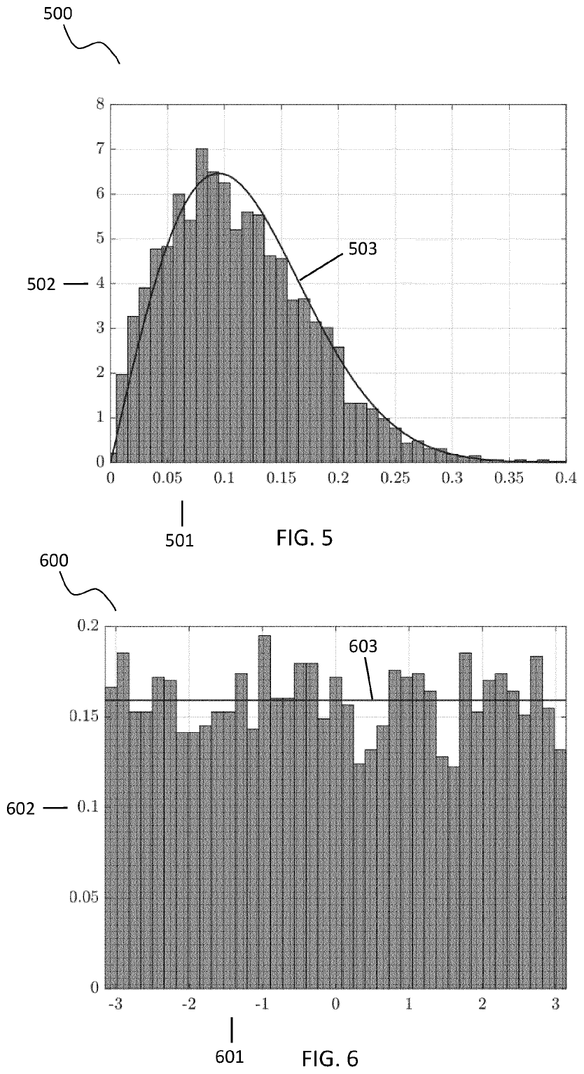

FIGS. 5-6 show histograms of the probability density of the amplitude and phase of the obtained unitary matrix for the setup simulated for FIG. 4B, respectively. In the plot 500, the x-axis 501 corresponds to the amplitude of each element in the matrix and the y-axis 502 corresponds to the probability density. The curve 503 superposed on top of the histogram represents the expected amplitude distribution for a Haar random matrix, fitting the data to a high degree. In the plot 600 om FIG. 6, the x-axis 601 corresponds to the phase of each element in the matrix and the y-axis 602 corresponds to the probability density. The curve 603 superposed on top of the histogram represents the expected phase distribution for a Haar random matrix, as well fitting the data to a high degree.

The expressibility of a measurement strategy to generate pure Gaussian states can be defined as its ability to produce ensembles of such states as well representative of a reference ensemble of Gaussian random matrices. The closeness of representation is measured in terms of a distance based on the well-known Haussdorff distance in set theory. A smaller distance is evidence that most states in the reference ensembles are represented closely by the induced ensemble and vice versa.

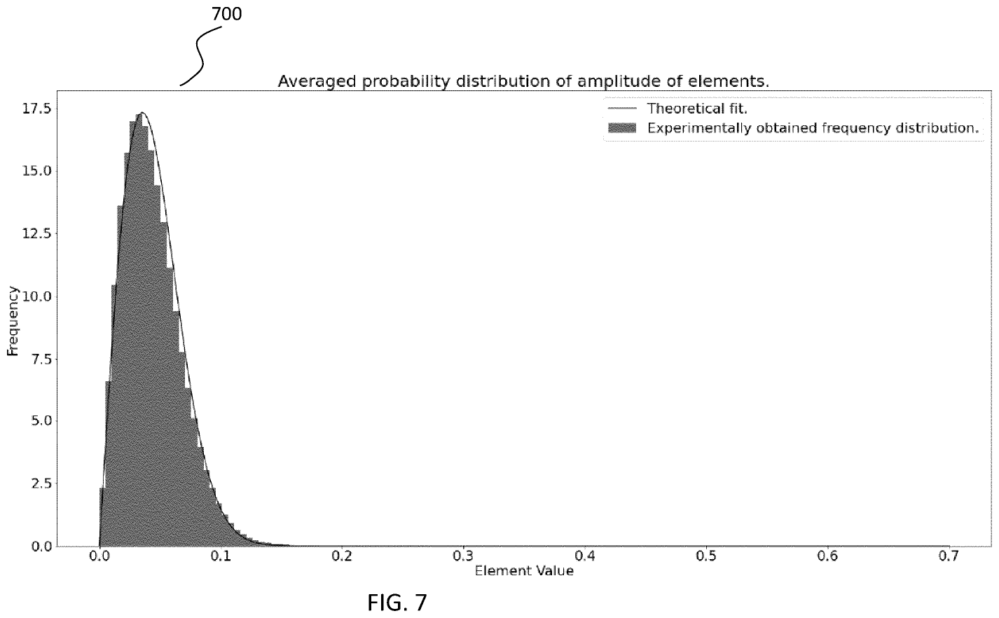

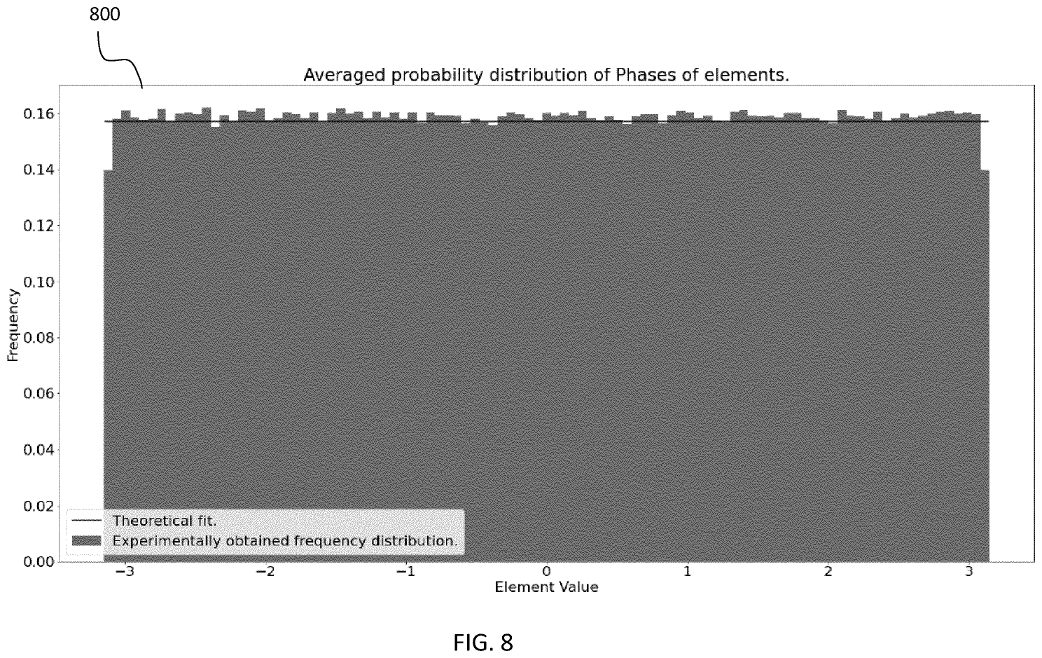

FIGS. 7-8 show the experimental distribution of amplitude and phase elements of the induced interferometers compared with an ideal interferometer picked from the Haar measure. In the absence of switching, linear measurements are used to induce a 400 mode Haar random interferometer. The results are an average of seven experiments that were carried out, creating a histogram with thinner bars due to the higher number of experimental samples created. Hence, FIGS. 7-8 show an experimental demonstration of the herein disclosed principle, supplementing the demonstration from the simulations in FIGS. 5-6.

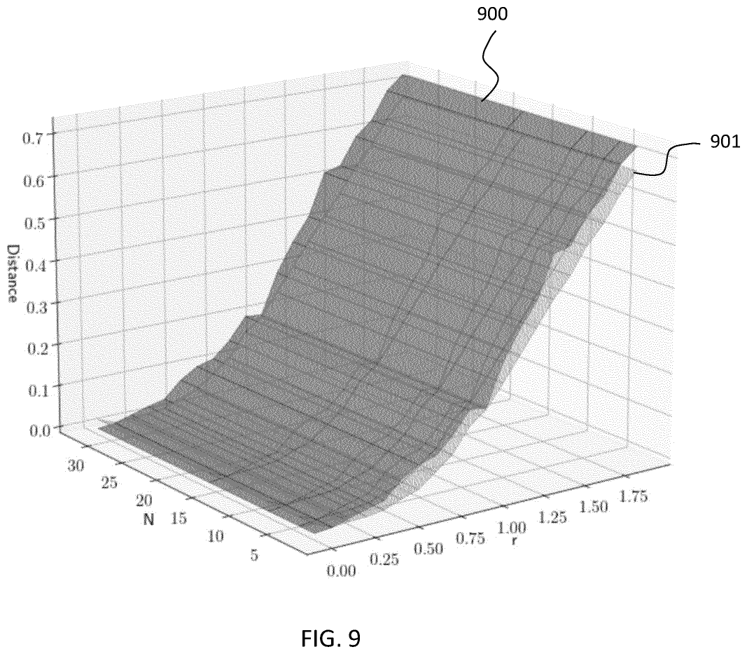

FIG. 9 shows the distance of ensembles created by the “linear measurements” illustrated in FIG. 1A and FIG. 3A and marked as 900 in FIG. 9, and the flexible approach illustrated in FIG. 1B and FIG. 3B and marked as 901 in FIG. 9, both from a reference ensemble. It can be seen that the flexible approach 901 offers a smaller distance over all squeezing levels, r, and interferometer sizes, N. The most optimal strategy in the case of the 1D cluster is the flexible approach from FIG. 1B, where the correlation matrix has four entries which is the maximum amount of entries one can have for the 1D cluster. For an N-mode unitary output 3N—2 modes are measured. The parameter space will be clearly larger here and that should also offer more control over the adjacencies produced.

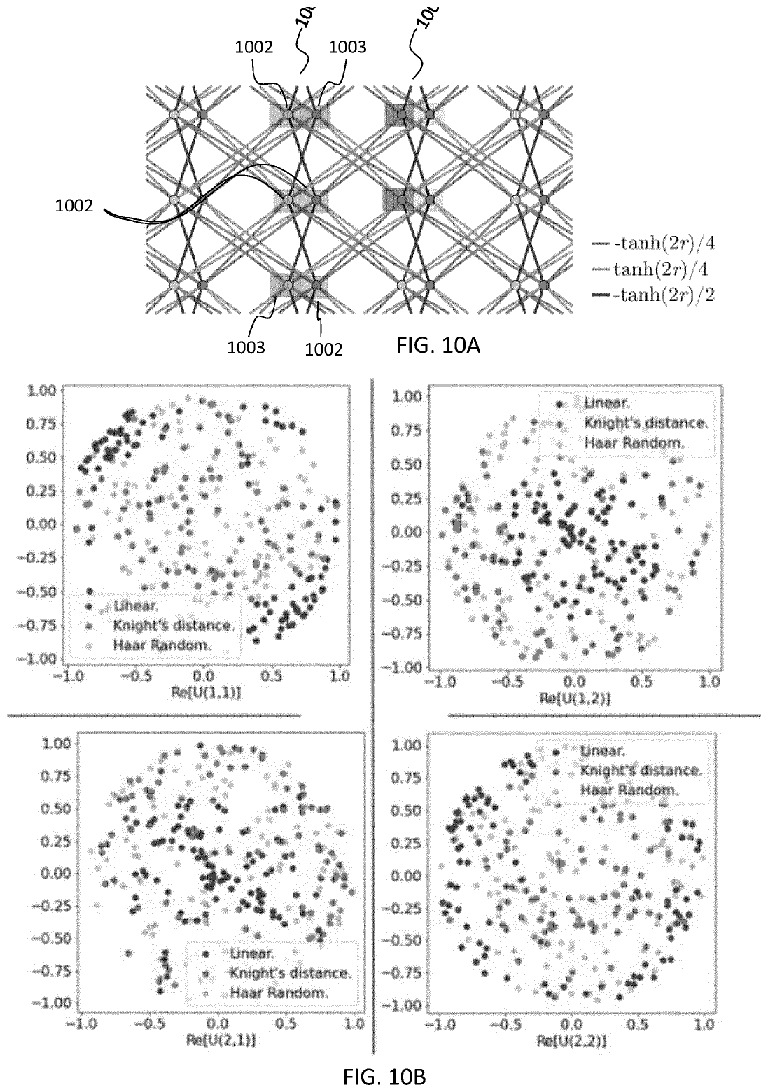

FIG. 10A shows the schemes of the “linear measurements” and the more flexible approach to produce in a 2D cluster. Reference numeral 1000 in FIG. 10A marks the linear measurement scheme (FIG. 1A) to produce a 2-mode state such that the modes in yellow (to the right) are measured out and the ones in red (to the left) are used as output modes. Similarly, reference numeral 1001 marks the flexible measurement approach (FIG. 1B) to produce a 2-mode state such that the four modes in green 1002 are measured out and the two modes in blue 1003 are used as output modes.

FIG. 10B shows the 2×2 unitary matrices produced in the process of inducing states using the aforementioned schemes. It can be seen that the points in blue are organized in a circle with unit radius on the diagonals and close to zero on the off diagonals which shows that these “blue unitary matrices'entries” which represent linear measurements are capable only of rotations while the red points are well distributed over the unit disc and show the capability of the flexible approach (FIG. 1B) to also produce mixing of modes and inducing correlations between modes. This is seen against a backdrop of Haar random unitary matrices'entries in green. Clearly, the measurements using the flexible approach (FIG. 1B) come closer to the distribution of Haar random unitary matrices.

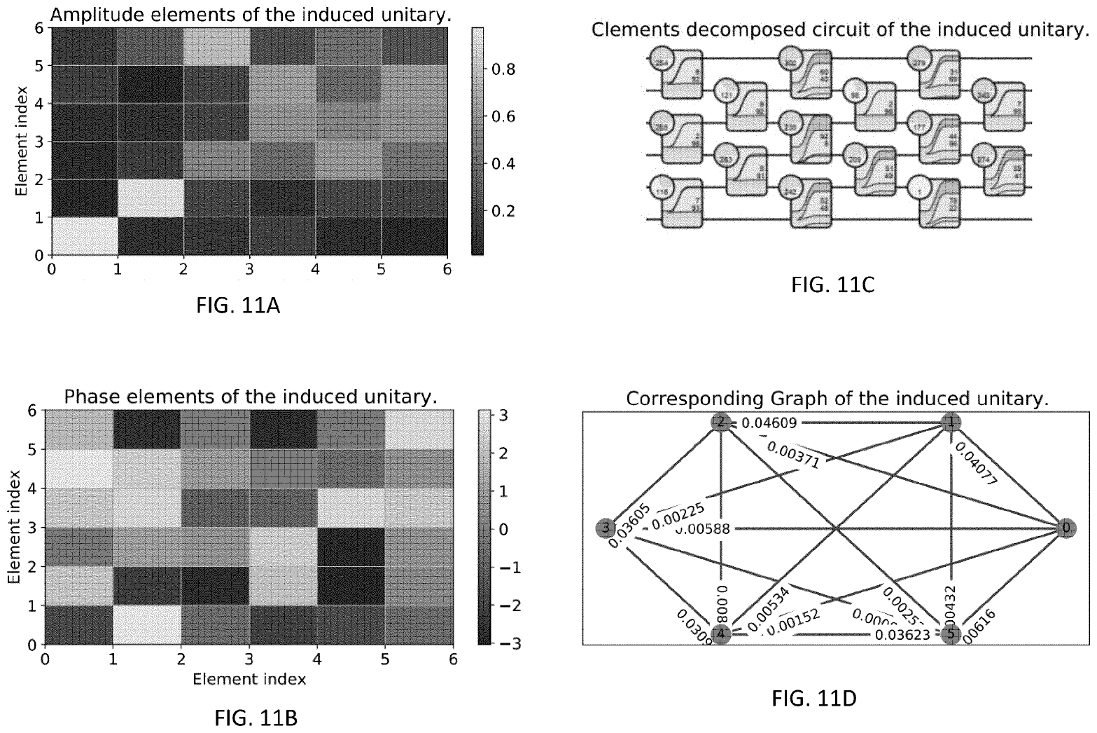

FIGS. 11A-D show an example of the experimental implementation of the presently disclosed approach by producing a six-mode state from the linear measurement scheme (FIG. 1A) on a 2D cluster state. FIG. 11D shows the graph corresponding to such a state, FIG. 11C shows the interferometer that induces this state, FIG. 11B show the phase elements of the unitary induced and FIG. 11A shows the amplitude elements of the measurement induced unitary. Altogether, the examples show that measurement induced interferometers can be induced in a scalable and accurate fashion compared to that of an ensemble of Haar random matrices.

### Items

1. A system for performing Gaussian Boson Sampling, comprising:
   a) an optical input generator,
   b) a time multiplexing unit configured for
      receiving from the optical input generator and transmitting at least a first part of the generated optical inputs through a first optical line,
      receiving from the optical input generator and transmitting at least a second part of the generated optical inputs through a second optical line,
      correlating the first part of optical inputs from the first optical line and the second part of optical inputs from the second optical line using a plurality of beam splitters,
      delaying the optical inputs in the second optical line using a number of delay lines located between the plurality of beam splitters,
   a measuring unit configured for
      measuring a property of the optical inputs using a homodyne detector at the end of the first optical line,
      delaying the optical inputs in the second optical line with a (long) delay line located after the last beam splitter,
      feed-forwarding an output signal, based on the measured property, to an optical displacement operator unit located after the (long) delay line in the second optical line,
      applying displacement operations to the optical inputs in the second optical line, and
      counting the optical inputs at the end of the second optical line.
2. The system according to item 1, wherein the optical input generator comprises at least one squeezed vacuum state generator.
3. The system according to any of the preceding items, configured such that the squeezed vacuum states generated by the at least one optical input generator are separated by a first time period.
4. The system according to any of the preceding items, wherein the beam splitters are configured in a balanced configuration 50:50.
5. The system according to any of the preceding items, configured such that each of the delay lines in the second optical line delay each squeezed vacuum state a predefined number of said first time periods.
6. The system according to any of the preceding items, configured such that the (long) delay line in the second optical line stores/delays the squeezed vacuum states for a second predefined time longer than the first predefined time.
7. The system according to any of the preceding items, configured such that the homodyne detector has a processing time for measuring the correlated squeezed vacuum states from the first optical line and for feed-forwarding a signal to the displacement unit.
8. The system according to any of the preceding items, wherein the measured property of the homodyne detector in the first optical line is a property of the correlated squeezed vacuum states, such as quadrature amplitudes of the electric field.
9. The system according to any of the preceding items, wherein the (long) delay line in the measuring unit is configured for delaying the correlated squeezed vacuum states a time corresponding to the processing time of the homodyne detector.
10. The system according to any of the preceding items, wherein the displacement operator is configured to perform displacement operations to the correlated squeezed vacuum states in the second optical line.
11. The system according to any of the preceding items, configured such that the displacement operations are performed in the position-momentum phase of the squeezed vacuum states in the second optical line are based on the measured properties by the homodyne detector on the squeezed vacuum states in the first optical line.
12. The system according to any of the preceding items, configured such that the configuration of the displacement operator is varied every first time period for every squeezed vacuum state.
13. The system according to any of the preceding items, wherein the detector counting the squeezed vacuum states in the second optical line is a single photon counter or a photon-number resolving detector, and/or wherein the first and second optical lines and the delay lines comprise a medium, such as (low loss) optical fiber and/or free air.
14. A method for performing Gaussian boson sampling comprising the steps of
   a) generating a set of pulsed pairs of squeezed vacuum states,
   b) performing time multiplexed correlation of multiple of such pairs of squeezed vacuum states,
   c) measuring, via a homodyne detection, a state from the pairs of generated squeezed vacuum states,
   d) feed-forwarding the homodyne result of the measured states to a displacement unit,
   e) performing displacement operations on the remaining state from the pairs of generated squeezed vacuum states, and
   f) counting the states output from the displacement unit.
15. The method according to item 14, executed using the system according to any of the items 1-13.

1. A system for performing Gaussian Boson Sampling, comprising:
an optical input generator,
a time multiplexing unit configured for
receiving, from the optical input generator, and transmitting at least a first part of the generated optical inputs through a first optical line,
receiving, from the optical input generator, and transmitting at least a second part of the generated optical inputs through a second optical line,
correlating the first part of optical inputs from the first optical line and the second part of optical inputs from the second optical line using a plurality of beam splitters,
delaying the optical inputs in the second optical line using a number of delay lines located between the plurality of beam splitters,
a measuring unit configured for
measuring, by means of a homodyne detector, a property of the optical inputs at the end of one of the first or the second optical line,
delaying, by means of a final delay line, the optical inputs in the other of the first or second optical line,
feed-forwarding an output signal, based on the measured property, to an optical displacement operator unit located after the final delay line,
applying displacement operations by means of the optical displacement operator, and
counting the optical inputs after the optical displacement operator, preferably by means of a photon counter.

2. The system according to claim 1, wherein the measuring unit is configured for switching between homodyne detection and photon counting for each optical input on both the first and the second optical line.

3. The system according to any of the preceding claims, wherein the measuring unit comprises a switch on each optical line for switching between homodyne detection and photon counting on each optical line.

4. The system according to any of claims 2-3, wherein each of the photon counters is preceded by a final delay line and an optical displacement operator unit, and where both the homodyne detector output signals can be feed-forwarded to the corresponding displacement operator unit.

5. The system according to any of the preceding claims, wherein the optical input generator comprises at least one squeezed vacuum state generator.

6. The system according to any of the preceding claims, configured such that the squeezed vacuum states generated by the at least one optical input generator are separated by a first time period.

7. The system according to any of the preceding claims, wherein the beam splitters are configured in a balanced configuration 50:50.

8. The system according to any of the preceding claims, configured such that each of the delay lines in the second optical line delay each squeezed vacuum state a predefined number of said first time periods.

9. The system according to any of the preceding claims, configured such that the final delay line stores the squeezed vacuum states for a second predefined time longer than the first predefined time.

10. The system according to any of the preceding claims, configured such that the homodyne detector has a processing time for measuring the correlated squeezed vacuum states and for feed-forwarding a signal to the displacement unit.

11. The system according to any of the preceding claims, wherein the measured property of the homodyne detector is a property of the correlated squeezed vacuum states, such as quadrature amplitudes of the electric field.

12. The system according to any of the preceding claims, comprising a digital signal processor configured to process the measured property and calculate the displacements for feed-forwarding.

13. The system according to any of the preceding claims, wherein the final delay line is configured for delaying the correlated squeezed vacuum states a time period corresponding to the processing time of the homodyne detector.

14. The system according to any of the preceding claims, wherein the displacement operator is configured to perform displacement operations to the correlated squeezed vacuum states.

15. The system according to any of the preceding claims, configured such that the displacement operations performed in the position-momentum phase of the squeezed vacuum states in the first or second optical line are based on the properties measured by the homodyne detector on the squeezed vacuum states in the other of the first or second optical line.

16. The system according to any of the preceding claims, configured such that the configuration of the displacement operator is varied every first time period for every squeezed vacuum state.

17. The system according to any of the preceding claims, wherein the detector counting the squeezed vacuum states in the second optical line is a single photon counter or a photon-number resolving detector

18. The system according to any of the preceding claims, wherein the first and second optical lines and the delay lines comprise a medium, such as a transmission medium, such as an optical fiber and/or free air.

19. A method for performing Gaussian boson sampling comprising the steps of
generating a set of pulsed pairs of squeezed vacuum states,
performing time multiplexed correlation of multiple of such pairs of squeezed vacuum states,
measuring, via a homodyne detection, a state from the pairs of generated squeezed vacuum states,
feed-forwarding the homodyne result of the measured states to a displacement unit,
performing displacement operations (by means of the displacement unit) on the remaining state from the pairs of generated squeezed vacuum states, and
counting the states output from the displacement unit.

20. The method according to claim 19, for performing quantum information experiments.

21. The method according to any of preceding claims 19-20, executed using the system according to any of the claims 1-18.
